(19) United States
(12) Patent Application Publication
(10) Pub. No.: US 2009/0246616 A1
(43) Pub. Date: Oct. 1, 2009

(54) BATTERY MODULE

(76) Inventors: Taihei KOYAMA, Tachikawa-shi (JP); Takeo Kakuchi, Chofu-shi (JP); Yosuke Tonami, Asaka-shi (JP); Takafumi Nakahama, Fuchu-shi (JP); Norihito Togashi, Yokohama-shi (JP); Kenji Sato, Hachioji-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/409,087

(22) Filed: Mar. 23, 2009

(30) Foreign Application Priority Data
Mar. 24, 2008 (JP) 2008-076814

(51) Int. Cl. H01M 6/46; H01M 2/12; H01M 6/42

(52) U.S. Cl. 429/153; 429/148; 429/151

(57) ABSTRACT

A battery module includes a plurality of batteries provided adjacent to one another. Each battery includes a case, which has a frame-shaped peripheral wall having open ends and a sidewall provided at one end of the peripheral wall, and a cell which is contained in the case and exposed at the other end of the peripheral wall. In two adjacent batteries of the batteries, the other end of a peripheral wall of one battery and one end of a peripheral wall of the other battery are opposed to each other.

### CROSS-REFERENCE TO RELATED APPLICATIONS

This application is based upon and claims the benefit of priority from prior Japanese Patent Application No. 2008-076814, filed Mar. 24, 2008, the entire contents of which are incorporated herein by reference.

### BACKGROUND OF THE INVENTION

1. Field of the Invention

This invention relates to a battery apparatus, in particular, a battery module formed of a plurality of secondary batteries.

2. Description of the Related Art

In recent years, battery module including a plurality of secondary batteries such as lithium ion secondary batteries has been widely recognized as useful power supply for electric vehicle or the like, since such battery module has high voltage and high energy density. Battery modules are disclosed in, for example, Japanese Patent Nos. 3014293 and 3350189. Each of the secondary batteries has a cell which can be charged and discharged, and a case containing the cell.

To increase voltage, the battery module is formed of a plurality of secondary batteries connected in series.

In the above structure, however, the battery module is heavy. Therefore, it is desired to reduce the weight of the battery module. In addition, since using a plurality of secondary batteries increases the size of the battery module, it is also desired to reduce the size of the battery module.

### BRIEF SUMMARY OF THE INVENTION

The present invention has been made in consideration of the above points. An object of the present invention is to provide a lightweight battery module.

To achieve the object, according to an aspect of the present invention, there is provided a battery module that comprises a plurality of batteries which is provided adjacent to one another, each battery comprising:

a case which has a frame-shaped peripheral wall having open ends, and a sidewall provided at one end of the peripheral wall; and

a cell which is contained in the case and exposed at the other end of the peripheral wall,

wherein, in two adjacent batteries of the batteries, the other end of a peripheral wall of one battery and one end of a peripheral wall of the other battery are opposed to each other.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a battery module according to an embodiment of the present invention.

FIG. 2 is an exploded perspective view of a battery taken out of the battery module.

FIG. 3 is a perspective view of the battery module, the view particularly showing a coupling state of batteries.

FIG. 4 is a perspective view of a modification of the battery module according to the embodiment of the present invention.

FIG. 5 is a perspective view of the battery module illustrated in FIG. 4, the view particularly showing a coupling state of batteries.

FIG. 6 is a perspective view of another modification of the battery module according to the embodiment of the present invention.

FIG. 7 is a perspective view of the battery module illustrated in FIG. 6, the view particularly showing a coupling state of batteries.

### DETAILED DESCRIPTION OF THE INVENTION

A battery module according to an embodiment of the present invention will now be described in detail below, with reference to drawings.

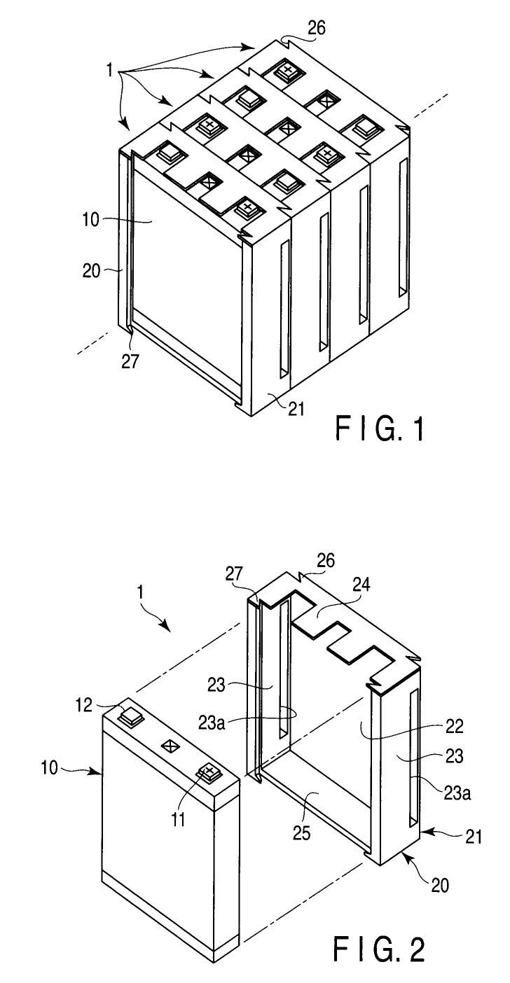

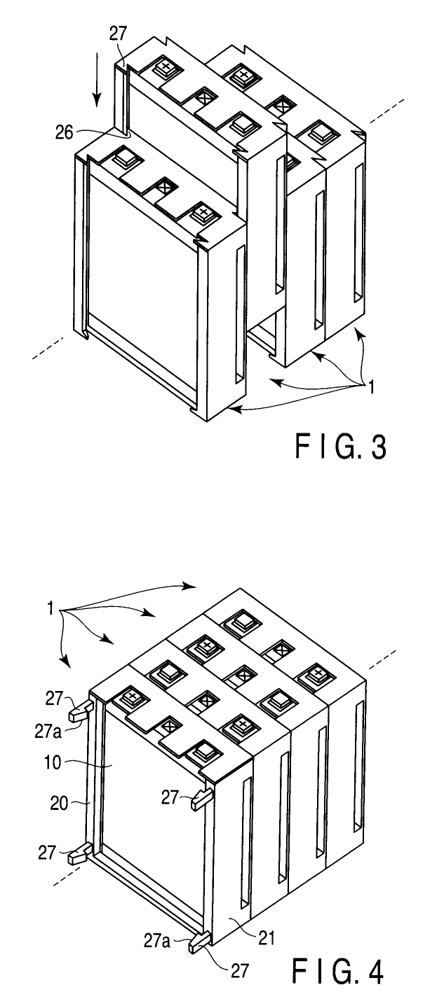

As illustrated in FIGS. 1 and 2, the battery module is formed of a plurality of batteries 1. In this embodiment, the batteries 1 are secondary batteries. Each battery 1 has a flat rectangular shape. Each battery 1 has a cell 10 and a case 20 containing the cell 10.

The cell 10 has a flat rectangular shape. The cell 10 has a positive electrode 11 and a negative electrode 12 which are formed on an external surface of the cell 10 and project outward. The cell 10 is formed by enclosing non-aqueous electrolysis solution in a flat rectangular aluminum housing.

The case 20 has a frame-shaped peripheral wall 21 having two open ends, and a sidewall 22 provided at one end of the peripheral wall 21. In this embodiment, the peripheral wall 21 is formed as a rectangular frame, and the sidewall 22 is formed to have a rectangular shape. The peripheral wall 21 is formed of two rectangular sidewalls 23, a rectangular top wall 24, and a rectangular bottom wall 25, which are integrated as one unit. The top wall 24 of the case 20 has cut-away portions.

The case 20 contains the cell 10. The case 20 exposes the cell 10 at the other end of the peripheral wall 21. The case 20 also exposes the positive electrode 11 and the negative electrode 12. The batteries 1 are charged and discharged through the positive electrodes 11 and the negative electrodes 12.

Each battery 1 has air holes 23a formed by opening parts of the peripheral wall 21. In this embodiment, the air holes 23 are formed in a stripe shape by opening parts of the respective sidewalls 23. The air holes 23a are connected to an air ventilation channel, which is provided inside the case 20 and contacts the cell 10, and contribute to cooling of the cell 10.

Each battery 1 has first engaging portion 26 formed at one end of the peripheral wall 21, and second engaging portion 27 formed at the other end of the peripheral wall 21. In this embodiment, the first engaging portion 26 is provided in the sidewall 22, and formed as wedge-shaped projections which extend along the extending direction of the sidewalls 23. The second engaging portion 27 is provided at the other end of the peripheral wall 21, and formed as wedge-shaped notches which extend along the extending direction of the sidewalls 23.

The batteries 1 are arranged in a line. The batteries 1 are provided adjacent to one another. In two adjacent batteries 1, the other end of the peripheral wall 21 of one battery 1 and one end of the peripheral wall 21 of the other battery 1 are opposed to each other. Although not shown, in this embodiment, the batteries 1 are connected in series. In two adjacent batteries 1, the positive electrode 11 of one battery 1 is connected to the negative electrode 12 of the other battery 1.

As illustrated in FIGS. 1 to 3, in two adjacent batteries 1, the first engaging portion 26 of one battery 1 is engaged with the respective second engaging portion 27 of the other battery 1, along the extending direction of the sidewalls 23. Two adjacent batteries 1 are coupled to each other. Therefore, the cells 10 of the two adjacent batteries 1 are opposed, with one sidewall 22 interposed therebetween. Although not shown, the other end of the peripheral wall 21 of the battery 1 located at an end of the battery module is covered with the sidewall having the first engaging portions 26.

According to the battery module having the above-described structure, each battery 1 has the case 20 and the cell 10 contained in the case 20. The case 20 has the open end which is located at the other end of the peripheral wall 21. In two adjacent batteries 1, the other end of the peripheral wall 21 of one battery 1 and one end of the peripheral wall 21 of the other battery 1 are opposed to each other. The cells 10 of two adjacent batteries 1 are opposed to each other, with one sidewall 22 interposed therebetween.

Therefore, the above battery module can achieve reduction in weight, in comparison with the case where sidewalls 22 are provided at both ends of the peripheral wall 21. Since the case 20 can be formed without providing another sidewall 22 at the other end of the peripheral wall 21, the manufacturing cost is reduced accordingly.

Further, since the case 20 can be formed without providing another sidewall 22 at the other end of the peripheral wall 21, the size of the battery module can be reduced accordingly. As another embodiment, it is possible to secure a sufficiently wide space for air holes 23a and the air ventilation channel inside the case 20, for the space saved by forming the case 20 without providing another sidewall 22 at the other end of the peripheral wall 21. In this case, the cooling efficiency of the cell 10 can further be enhanced.

Each battery 1 has the first engaging portion 26 and the second engaging portion 27. In two adjacent batteries 1, the first engaging portion 26 of one battery 1 is engaged with the respective second engaging portion 27 of the other battery 1. Since batteries 1 can be coupled without bolts or screws, the products can be easily assembled. Since manufacturing parts such as bolts and screws can be reduced, the manufacturing cost can also be reduced.

According to the above, it is possible to obtain a lightweight battery module. Further, it is possible to obtain a compact battery module or a battery module having excellent cooling efficiency.

The present invention is not limited to the above embodiment, but can be carried out by modifying its constituent elements within a range not departing from the gist of the invention. Further, various inventions can be made by proper combinations of the constituent elements disclosed in the above embodiment. For example, some of the constituent elements disclosed in the embodiment may be removed.

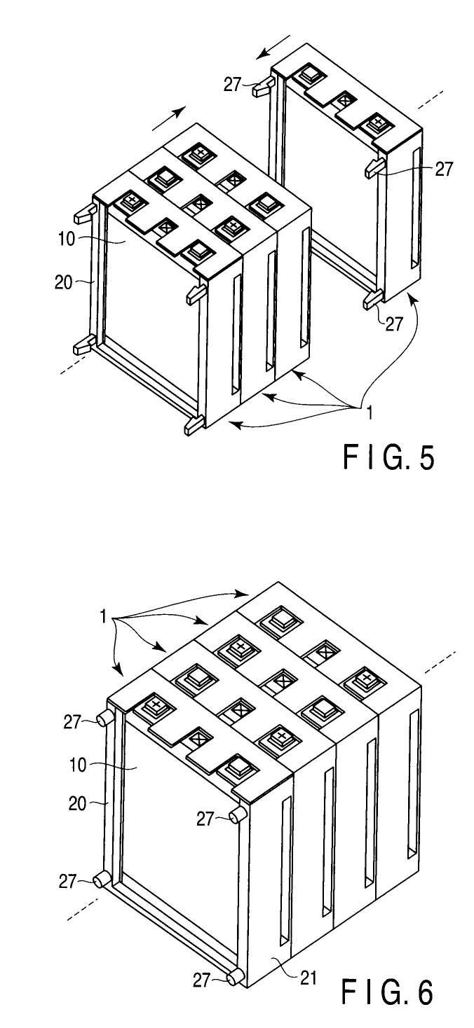

The first engaging portion 26 and the second engaging portion 27 are not limited to the above embodiment, but can be variously modified. For example, in one modification, as illustrated in FIGS. 4 and 5, the first engaging portion 26 is formed as four hole portions (not shown) formed at one end of the peripheral wall 21, and the second engaging portion 27 is formed as four projecting portions formed at the other end of the peripheral wall 21. Hook portions 27a provided on the projecting portions couple and fix two adjacent batteries 1 to each other. This structure can improve the assembly workability.

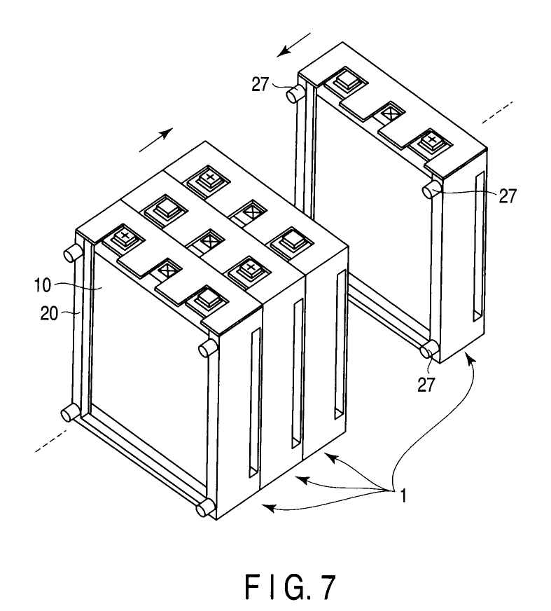

In another modification, as illustrated in FIGS. 6 and 7, the first engaging portion 26 is formed as four hole portions (not shown) formed at one end of the peripheral wall 21, and the second engaging portion 27 is formed as four projecting portions formed at the other end of the peripheral wall 21. Although no hook portions 27a are provided on the projecting portions, the projecting portions are tapered, and thereby the first engaging portion 26 can be engaged with the second engaging portion 27 in good condition. Further, this structure can improve the assembly workability.

As mentioned above, each case 20 includes the two air holes 23a. However, it may include one air hole, or three or more air holes.

What is claimed is:

1. A battery module that comprises a plurality of batteries which is provided adjacent to one another, each battery comprising:
a case which has a frame-shaped peripheral wall having open ends, and a sidewall provided at one end of the peripheral wall; and
a cell which is contained in the case and exposed at the other end of the peripheral wall,
wherein, in two adjacent batteries of the batteries, the other end of a peripheral wall of one battery and one end of a peripheral wall of the other battery are opposed to each other.

2. The battery module according to claim 1, wherein each of the batteries has an air hole which is formed by opening part of the peripheral wall.

3. The battery module according to claim 1, each battery further comprising:
a first engaging portion formed at one end of the peripheral wall; and
a second engaging portion formed at the other end of the peripheral wall,
wherein, in two adjacent batteries of the batteries, the first engaging portion of one battery is engaged with the second engaging portion of the other battery.
